(19) United States
(12) Patent Application Publication
(10) Pub. No.: US 2024/0275099 A1
(43) Pub. Date: Aug. 15, 2024

(54) METHOD FOR MANUFACTURING A FEMALE ELECTRICAL TERMINAL, AND FEMALE ELECTRICAL TERMINAL

(71) Applicants: TE Connectivity India Private Limited, Bangalore (IN); Tyco Electronics France SAS, Pontoise (FR)

(72) Inventors: Sundareshan M D, Pontoise (FR); Rakesh R S, Bangalore (IN); Xavier ROUILLARD, Pontoise (FR)

(21) Appl. No.: 18/438,749

(22) Filed: Feb. 12, 2024

(30) Foreign Application Priority Data
Feb. 13, 2023 (IN) 202341009385

(51) Int. Cl. H01R 13/11; H01R 13/04; H01R 43/16

(52) U.S. Cl. CPC H01R 13/113; H01R 13/04; H01R 43/16

(57) ABSTRACT

A method for manufacturing a female electrical terminal includes the steps of providing a sheet metal blank and forming the sheet metal blank to include a wiring portion for the attaching of an electrical wire and a receiving portion for the receiving of a male electrical terminal in a receiving direction. The receiving portion includes a base portion and two lateral portions. Each lateral portion including an end portion configured to form a top surface of the receiving hollow, at least one link beam linking the end portion to the base portion, and a support beam also linking the end portion to the base portion. The method includes a further step of bending the lateral portions to form the receiving hollow and an additional step of modifying, in particular, reducing, at least one dimension of the support beam.

### CROSS REFERENCE TO RELATED APPLICATIONS

This application claims the benefit of IN Application No. 202341009385, filed 13-Feb.-2023, the subject matter of which is herein incorporated by reference in its entirety.

### BACKGROUND OF THE INVENTION

The subject matter herein relates to a method for manufacturing a female electrical terminal, to a female electrical terminal, and to an electrical terminal assembly.

It is known to establish an electrical connection by assembling together two electrical terminals, each respectively attached to an end of a conducting electrical wire. For example, typically, a male electrical terminal is inserted in a receiving hollow of a female electrical terminal to realize an electrical contact. The quality of the electrical connection is determined at least partly by the forces holding together the assembled electrical terminals.

For example, when a male electrical terminal is received in a female electrical terminal, the contact normal force exerted by the mechanical structure of the female electrical terminal structure on the received male electrical terminal can counteract relative movements of the terminals and prevent an unwanted extraction of the male electrical terminal. In particular, the contact normal force should be higher than the mechanical vibration-induced acceleration forces exerted on the electrical terminal assembly.

However, the intensity of the vibrational load exerted on the electrical terminal assembly is specific to each environment and each application of the electrical terminal assembly. For example, the level of mechanical vibration in a vehicle application in proximity to the engine can be much higher than, for example, in an immobile and/or environmentally insulated industrial application. Further, the electrical current intensity to be carried by the electrical connection may vary from application to application, and thus, within a range, the dimensions, i.e. mass, of the conducting wires to be attached to the terminals may also vary, thereby impacting the vibrational load on the assembly.

For cost-efficiency purposes, it is therefore typical to design electrical terminal assemblies conservatively, providing for a sufficiently high contact normal force to guarantee a reliable electrical connection in a wide range of environments and applications. In other words, in conventional electrical terminal designs the contact normal force, or contact structural resilience, is over-dimensioned with respect to the real application requirement, exceeding the actual requirements by an unwarranted margin.

This leads to unneeded user discomfort when assembling and/or disassembling electrical terminal systems. In particular, the insertion and/or extraction of a male electrical terminal in or from the receiving hollow of the female electrical terminal can require excessive force for the user, for example for the cable installer.

Further, a risk of damage to the metal plating of portions of the electrical terminals during insertion and/or extraction is increased, reducing the reusability of the terminals and the quality of the electrical connection.

It is therefore an object of the present invention to provide an electrical connection solution overcoming the described deficiency in prior art. In particular, it is an object of the present invention to provide a cost-efficient electrical terminal assembly providing a better balance of electrical connection reliability and user comfort.

### BRIEF DESCRIPTION OF THE INVENTION

In an embodiment, a method for manufacturing a female electrical terminal is provided including the steps of a) providing a sheet metal blank, b) forming the sheet metal blank to comprise a wiring portion for the attaching of an electrical wire, and a receiving portion for the receiving of a male electrical terminal in a receiving direction, the receiving portion comprising a base portion and two lateral portions, the base portion being configured to form a bottom surface of a receiving hollow of the manufactured female electrical terminal and comprising a contacting portion for an electrical contacting with the received male electrical terminal, and each lateral portion comprising, respectively: an end portion configured to form a top surface of the receiving hollow, at least one link beam linking the end portion to the base portion, and a support beam also linking the end portion to the base portion, the support beam having predetermined dimensions including a thickness, a width along the receiving direction, and a length in a plane orthogonal to the receiving direction, c) bending the lateral portions to form the receiving hollow, and d) modifying, in particular, reducing, at least one dimension of the support beam, in particular the thickness, and/or the width, and/or the length.

According to this method, a female electrical terminal is manufactured that comprises a support beam linking the base portion, forming a bottom surface of the receiving hollow, and the end portion, configured to form a top surface of the receiving hollow. That is, the support beam links, or connects together structurally, the end portion and the base portion in between which the male electrical terminal is held when it is received in the receiving hollow. The dimensions of the support beam therefore contribute to the resilience property of an elastic spreading apart of the end portion and the base portion, respectively defining a top and bottom surface of the receiving hollow female electrical terminal.

By modifying a dimension of the support beam, the contact normal force of the electrical terminal assembly, when a male electrical terminal is received in the receiving hollow of the female electrical terminal, is also modified. Thus, the female electrical terminal can be modified to match more closely the application-specific need, with respect to the contact normal force. For example, a reduction of a dimension such as the thickness of the support beam can reduce the contact normal force of the electrical terminal assembly, and consequently also facilitate insertion and extraction of the male electrical terminal.

In one aspect of the method, step d) can be executed between step b) and step c). When the support beam is modified before the bending, the modification can be implemented conveniently with the same tool used to form, for example stamp or punch, the sheet metal blank.

In another aspect of the method, step d) can be executed after step c). In this configuration, the support beam is modified after the bending. For example, the female electrical terminal can be manufactured, transported, sold and stored with a generic, unmodified, support beam. The modification of step d) can then be performed during electrical terminal assembly installation by a conversion tool kit, in accordance with the need of the specific installation.

In one aspect of the method, the dimension can be modified, in particular reduced, as a function of a property, in particular the diameter and/or size of the core, of the electrical wire to be attached to the wiring portion. The type of electrical wire, for example the diameter or cross-sectional area, together with the length of the electrical wire, determines the mass of the wire and therefore the acceleration force compounded by vibrations on the electrical terminal assembly. In this configuration, the female electrical terminal can be adapted to provide a contact normal force matching need corresponding to the type of the electrical wire.

In one aspect of the method, the dimension can be modified, in particular reduced, as a function of an insertion force requirement of the insertion of the male electrical terminal in the receiving hollow, in particular an insertion force minimum and/or maximum. In this configuration, the female electrical terminal can be adapted to improve user comfort during male terminal insertion without risking reliability of the electrical connection of the electrical terminal assembly.

In one aspect of the method, the dimension can be modified, in particular reduced, as a function of a removal force requirement of the removal of the male electrical terminal from the receiving hollow, in particular a removal force minimum and/or maximum. In this configuration, the female electrical terminal can be adapted to improve user comfort during male terminal extraction without risking reliability of the electrical connection of the electrical terminal assembly.

In one aspect of the method, the dimension can be modified, in particular reduced, as a function of a contact normal force requirement of the electrical contact of the male electrical terminal received in the female electrical terminal, in particular a contact normal force minimum and/or maximum. In this configuration, the female electrical terminal can be adapted to provide a contact normal force matching more closely an application-specific need. Thus, user comfort can be improved during installation, in particular male terminal insertion and/or extraction, and the risk of damage to the metal plating of portions of the electrical terminals during insertion and/or extraction can be reduced.

In an embodiment, a female electrical terminal is provided including a wiring portion for the attaching of an electrical wire, and a receiving portion for the receiving of a male electrical terminal in a receiving direction in a receiving hollow, the receiving portion comprising a base portion and two lateral portions, wherein the two lateral portions are bent with respect to the base portion to form the receiving hollow, the base portion forming a bottom surface of the receiving hollow and comprising a contacting portion for an electrical contacting with the received male electrical terminal.

The female electrical terminal is characterized in that each lateral portion comprises, respectively: an end portion forming a top surface of the receiving hollow, a first link beam and a second link beam, the link beams arranged in parallel and linking the end portion to the base portion, wherein the first link beam is arranged at a proximal end of the receiving portion in the receiving direction, and the second link beam is arranged at a distal end of the receiving portion in the receiving direction, and a support beam also linking the end portion to the base portion, the support beam being arranged in parallel to and in between the first and the second link beam.

A female electrical terminal thus configured includes in a side area at least three beams, at least one of which, the support beam, is arranged between the other two (link) beams. The design, i.e. structural geometry, of the support beam therefore predominantly contributes to or determines the contact normal force of the terminal, that is, when assembled with a mating male electrical terminal. Specifically, the contact normal force is determined by the resilience of the bent end portion of the lateral portion linked to the base portion by the link beams and the support beam, and, for example, a thickness of an insertion portion of the mating male electrical terminal.

The arrangement of the support beam allows for a convenient modification of its structure in accordance with an application-specific requirement of the female electrical terminal. The modification is convenient both in a pre-bending state, when the formed sheet metal is yet unbent, and in a post-bending state, when the sheet metal is bent to form the receiving hollow of the female electrical terminal.

The female electrical terminal according to the invention can be cost-efficiently mass-produced and used across a variety of applications and environments, and at the same time be more accurately adapted to the vibrational load of the application. Thus, the user comfort is increased and the risk of damage to contact surfaces during use reduced, without any loss in electrical connection reliability.

In one aspect of the terminal, the support beam can have a thickness smaller, in particular 5% to 90% smaller, than a corresponding thickness of the first and/or of the second link beam. In this configuration, the support beam has a reduced thickness, and thus the resilience of the bent end portion with respect to the base portion is also reduced, reducing the contact normal force. A thus configured female electrical terminal can be more suitable with lower-than-maximal vibrational load requirements.

In one aspect of the terminal, the support beam can have a width along the receiving direction smaller, in particular 5% to 90% smaller, than a corresponding width of the first and/or of the second link beam. In this configuration, the support beam has a reduced width, and thus the resilience of the bent end portion with respect to the base portion is also reduced, reducing the contact normal force. A thus configured female electrical terminal can be more suitable with lower-than-maximal vibrational load requirements.

In one aspect of the terminal, the second link the beam can comprise a notch in a region of joining of the second link beam and the base portion, in particular wherein the notch faces in the receiving direction and has a depth of 10% to 50% of the width of the second link beam. A notch placed in a region joining of the second link beam and the base portion can avoid an accumulation of stress in the region, which is notable specifically in the case of ultrasonic welding of the core of the electrical wire to the wiring portion. If the natural frequency of the welding and of the terminal coincide, the amplitude of micro-motions at the region joining the wiring portion to the receiving portion can increase. Thus, the notch reduces the risk of resonance-effect-related damage to the receiving portion.

In one aspect of the terminal, the end portions of the respective lateral portions, when bent to form the receiving hollow, can define, in a plane orthogonal to the receiving direction and/or in a plane parallel to the receiving direction, a U-shaped top surface. When end portions are bent to form a U-shape in the plane parallel to the receiving direction and/or the plane orthogonal to the receiving direction, the edges can be softened and chafing or damage to metal plating reduced.

The invention further relates to an electrical terminal assembly comprising a female electrical terminal according to one of the above-described aspects, or manufactured by the method according to any one of above-described aspects, and a male electrical terminal, wherein the male electrical terminal is received in the receiving hollow such that a first surface of the male electrical terminal abuts with the contacting portion of the female electrical terminal, and a second surface of the male electrical terminal opposed to the first surface abuts with the end portions of the female electrical terminal, realizing the electrical contacting.

In a thusly configured electrical terminal assembly, the contact normal force of the male electrical terminal received in the receiving hollow of the female electrical terminal can be more closely adapted to the application, as described above with respect to the method for manufacturing and the female electrical terminal.

In one aspect of the terminal assembly, a thickness, and/or a width along the receiving direction, and/or a length in a plane orthogonal to the receiving direction, of the support beam, can be a function of a property, in particular the diameter and/or size of the core, of the electrical wire to be attached to the wiring portion. In this way, the contact normal force can be more precisely adapted to the wire type, and thus at the same time provide higher user comfort during electrical terminal assembly installation.

In one aspect of the terminal assembly realizing an electrical connection in an application environment, the contact normal force of the electrical contacting can correspond to, in particular be greater than, preferably up to 10% greater than, the vibration acceleration force of the application environment. In comparison to prior art, this electrical terminal assembly can have a contact normal force adapted to a vibration acceleration force related to the application, and thus guarantee a reliable electrical connection without dimensioning the contact normal force too excessively.

### BRIEF DESCRIPTION OF THE DRAWINGS

These, as well as other objects and advantages of this invention will be more completely understood and appreciated by careful study of the following more detailed description of the presently preferred exemplary aspects and embodiments of the invention, taken in conjunction with accompanying drawings, in which:

FIG. 1 shows a perspective view of a female electrical terminal according to a first embodiment of the invention;

FIG. 2 shows a side view of the terminal of FIG. 1;

FIG. 3 shows a cross-sectional view of the terminal of FIG. 1;

FIG. 4 shows a side view of a male electrical terminal;

FIG. 5A illustrates schematically the steps of a method according to a second embodiment of the invention;

FIG. 5B illustrates schematically the steps of a method in a variant of the second embodiment;

FIG. 6 shows a plane top view of a formed sheet metal in a method according to a second embodiment of the invention;

FIG. 7 shows the female electrical terminal of FIG. 1 modified according to the method of the second embodiment.

### DETAILED DESCRIPTION OF THE INVENTION

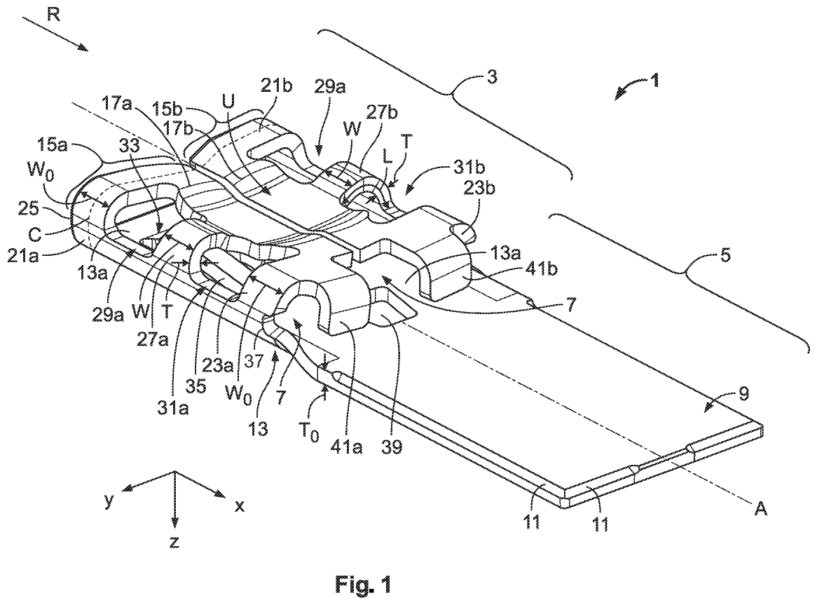

A female electrical terminal according to a first embodiment of the invention will now be described with reference to FIGS. 1, 2 and 3. The female electrical terminal 1 shown on FIGS. 1, 2 and 3 can be obtained by a method for manufacturing a female electrical terminal according to the invention, of which an embodiment will be described subsequently.

In this example, the female electrical terminal 1 is manufactured by a stamping and bending of sheet metal, in particular of a copper-nickel-silicon alloy or a copper-chrome-titanium-silicon alloy. In some variants, the sheet metal can comprise a metal plating to enhance corrosion-resistance and conductivity properties, in particular a silver plating.

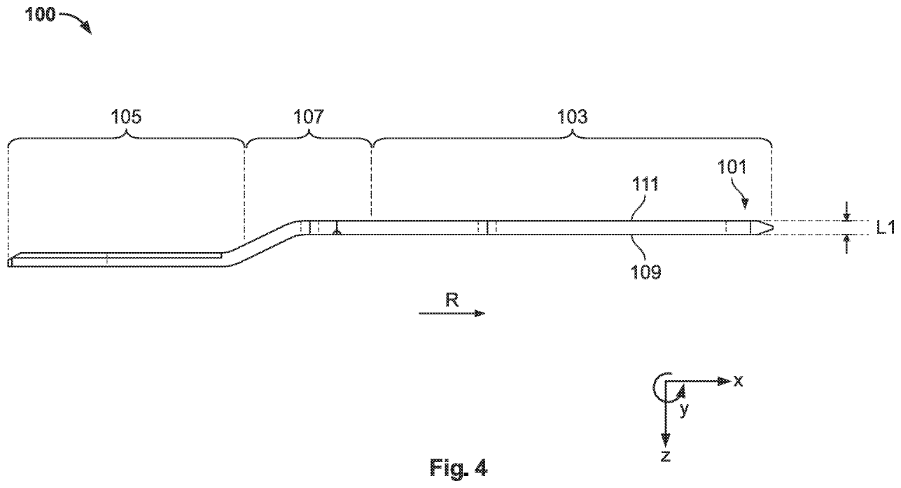

FIG. 1 shows a perspective view of the female electrical terminal 1 arranged along a receiving direction R for the receiving of a male electrical terminal, such as the male electrical terminal 100 described with reference to FIG. 4. The female electrical terminal 1 comprises, in the receiving direction R, a receiving portion 3 and a wiring portion 5. The receiving portion 3 defines a receiving hollow 7 configured to receive a male electrical terminal in the receiving direction R and along a central axis A defined by the female electrical terminal 1.

The wiring portion 5 is configured for the attaching of an electrical wire, in particular of the conducting core of an electrical wire, to establish an electrical connection. The wiring portion 5 has a flat, thin shape and a rectangular wiring surface 9 extending in a plane x-y parallel to the receiving direction R. The edges 11 along the wiring surface 9 are chamfered.

In this embodiment, the wiring portion 5 is suitable for the attaching of a core of the electrical wire by ultrasonic metal welding on the wiring surface 9. However, in alternative embodiments, the wiring portion of the female electrical terminal can be suited for an attaching of an electrical wire by alternative means, for example by soldering or crimping. The presently described embodiment is suitable for wire types having cross-sectional areas within a range of 0.1 mm² to 120 mm², and more preferably within a range of 6 mm² to 35 mm².

The entire female electrical terminal 1, as well as the wiring portion 5 and the receiving portion 3, are plane-symmetrical with respect to a plane centered on the central axis A and parallel the receiving direction R.

To this effect, the receiving portion 3 comprises a base portion 13, forming a bottom side of the receiving portion 3 and providing a bottom surface 13a for the receiving hollow 7. In addition, the receiving portion comprises two lateral portions 15a, 15b arranged on either side of the base portion 13 with respect to the central axis A, symmetrically facing each other. The lateral portions 15a, 15b are bent with respect to the base portion 13 to form, that is, to close the envelope of, the receiving hollow 7.

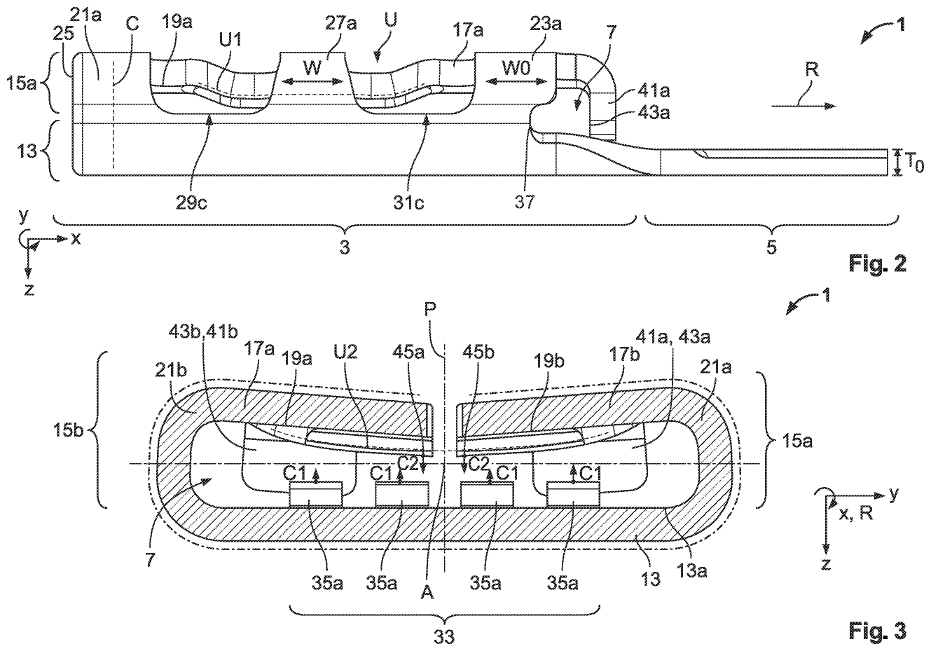

Each lateral portion 15a, 15b comprises, respectively, an end portion 17a, 17b providing a top surface 19a, 19b (see FIGS. 2, 3 and 5) of the receiving hollow 7, and a number of beams connecting the end portions 17a, 17b to the base portion 13. Specifically, each lateral portion 15a, 15b comprises a first link beam 21a, 21b, and a second link beam, 23a, 23b, the link beams 21a-23a, 21b-23b being arranged in parallel and linking their respective end portion 17a, 17b to the base portion 13. Each first link beam 21a, 21b is arranged at a proximal end of the receiving portion 3 in the receiving direction R, and each second link beam 23a, 23b is arranged at a distal end of the receiving portion 3 in the receiving direction R. In other words, each first link beam 21a, 21b is arranged at the extremity of the terminal 1 at the opening 25 of the receiving hollow 7, and each second link beam 23a, 23b is arranged in a region of joining of the receiving portion 3 and the wiring portion 5.

According to the present invention, the lateral portions 15a, 15b of the terminal 1 further comprise, respectively, a support beam 27a, 27b, also linking a respective end portion 17a, 17b to the base portion 13. Each support beam 27a, 27b is arranged in parallel to and in between a respective first 21a, 21b and second 23a, 23b link beam.

Therefore, on each symmetrical side of the receiving portion 3 with respect to the central axis A, a first lateral space 29a, 29b is defined between a first link beam 21a, 21b, a support beam 27a, 27b, an end portion 17a, 17b and a base portion 13. Similarly, on each symmetrical side of the receiving portion 3 with respect to the central axis A, a second lateral space 31a, 31b is defined between a support beam 27a, 27b, a second link beam 23a, 23b, an end portion 17a, 17b and a base portion 13.

The support beams 27a, 27b have a thickness T, which corresponds in the embodiment of FIG. 2 to the thickness of the bent sheet metal further reduced by a predetermined quantity. That is, the maximum thickness T of the support beam 27a, 27b is the thickness T0 of the sheet metal blank before being modified, here also the thickness of the first and second link beams 21a, 21b, 23a, 23b.

In the present embodiment, the thickness T is reduced with respect to T0 by 5%. However, in variants, the thickness T can be reduced by other values. In particular, the thickness T can be 5% to 90% smaller, than a corresponding thickness of the first and/or second link beam.

Further, the support beams 27a, 27b have a width W corresponding to the extension along the receiving direction R parallel to the central axis A. In this embodiment, the width W is 10% smaller, than the corresponding width W0 of the first 21a, 21b and second 23a, 23b link beams. However, in variants, the width W can have other values, in particular can be between 5% and 90% smaller, than W0.

The support beams 27a, 27b also have a length L, corresponding to the extension of the path of the support beams 27a, 27b between base portion 13 and end portions 17a, 17b, as projected on a plane orthogonal to the receiving direction R. In some variants, the length L can be modified, in particular shortened by reducing the bending curvature of the path, for example shortened by between 5% and 30%, such as by 10% or 20%.

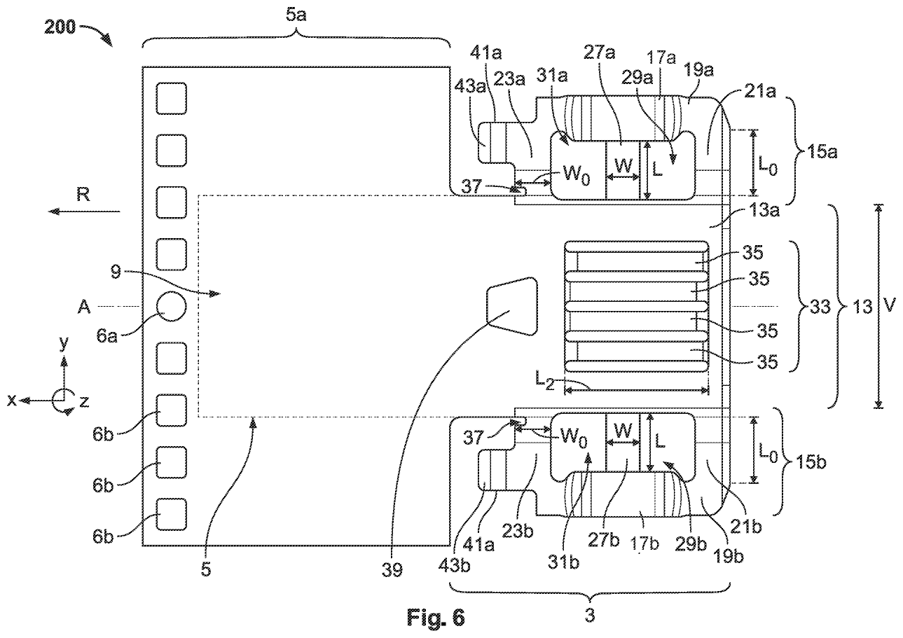

The base portion 13 comprises a contacting portion 33 consisting of four lamellae 35, stamped in the base portion 13 and bent upwards, that is, into the receiving hollow 7, for an electrical contacting with a received male electrical terminal. Only one lamellae 35 is visible on FIG. 1. The configuration and functionality of the contacting portion 33 will be further described in view of FIGS. 3 and 6.

FIG. 1 also shows that the second link beam 23a comprises a notch 37 in a region of joining of the second link beam 23a and the base portion 13. The notch 37 faces in the receiving direction R and has a depth of 10% to 50% of the width of the second link beam. A symmetrically arranged notch in the second link beam 23b is not visible on FIG. 1. The notches 37 prevent an accumulation of stress in a critical region of bending and joining from micro-motions during ultrasonic metal welding.

In a region of joining of the wiring portion 5 and the base portion 13 of the receiving portion, a through hole 39 traverses the metal sheet. The through hole 39 can be used as locking area for a locking of the terminal 1 to a housing, and also improves the plastic properties of the terminal 1 to facilitate bending during manufacture. The end portions 17a, 17b comprise, when bent together to form the receiving hollow 7, a depressed region U protruding inwardly in the hollow 7, which will further described in the following.

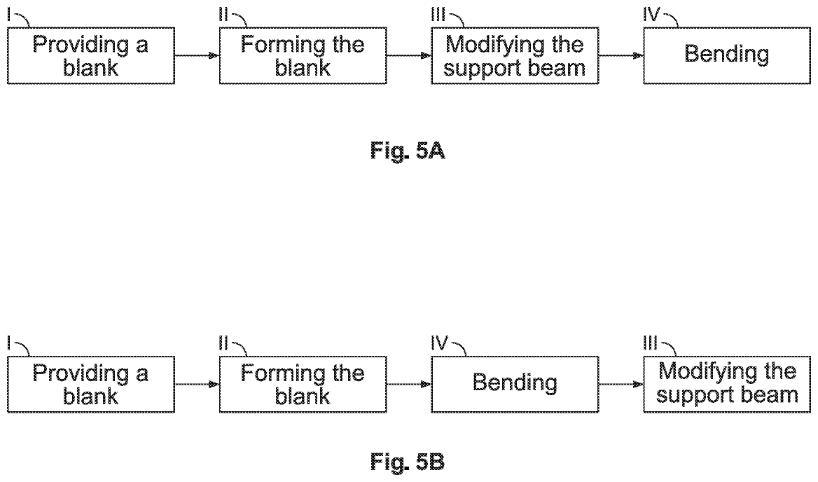

Further, the lateral portions 15a, 15b comprise, in the respective regions of joining of the end portions 17a, 17b and the second link beams 23a, 23b, respective rear protrusions 41a, 41b. The rear protrusions 41a, 41b extend in the receiving direction R, towards the wiring portion 5 and are bent downwards, defining a rear surface 43 (see FIGS. 3 and 5) for the receiving hollow 7. The rear protrusions 41a, 41b counteract compression of the female electrical terminal 1 along a direction z orthogonal to the receiving direction R, for example during handling and installation, and thus prevent plastic deformation.

FIG. 2 shows a plane side view of the female electrical terminal 1 in a plane x-z parallel to the receiving direction R. As already previously described, terminal 1 in FIG. 2 comprises a receiving portion 3 defining a receiving hollow 7, and a wiring portion 5. The receiving portion 3 comprises a base portion 13 and a lateral portion 15a. The lateral portion 15a comprises an end portion 17a, as well as, in sequence along the receiving direction R, a first link beam 21a, a support beam 27a and a second link beam 23a, each linking the end portion 17a to the base portion 13. The beams 21a, 27a, 23a are arranged in parallel and define the lateral spaces 29a, 31a. The support beam 23a comprises the notch 37 already described with reference to FIG. 1.

The receiving hollow 7 is enclosed by a bottom surface 13a (not visible on FIG. 2), the rear surfaces 43a, 43b defined by the bent rear protrusions 41a, 41b, a top surface 19a, 19b defined by the end portions 17a, 17b, and the opening 25 for the receiving of a male electrical terminal in receiving direction R.

The support beam 27a has a width W 10% smaller than the width W0 of the second link beam 23a, and a thickness T (not visible) 5% smaller than the thickness T0 of the unmodified sheet metal, here for example shown in a region of the wiring portion 5.

As can be seen on FIG. 2, the end portions 17a, 17b (only 17a visible) bent to form the top surface 19a, 19b (only 19a visible) of the receiving hollow 7 comprise a depressed region U. Specifically, the end portions 17a, 17b are bent such that in a plane x-z parallel to the receiving direction R, the top surface 19a, 19b is U-shaped, as shown in reference U1. In other words, the end portions 17a, 17b are bent to form the U-shape U1 in the top surface 19a, 19b.

In the end portions 17a, 17b, the depression U1 is formed to be inwardly protruding into the receiving hollow 7. This improves the grip of an electrical contact with an inserted male electrical terminal, but also, through the rounded edges of the U-shape, softens the insertion and extraction of the male electrical terminal, thus further reducing chafing and damage to metallic surfaces.

FIG. 3 shows a cross-sectional view of the receiving portion 3 of the female electrical terminal 1 according to the cross-sectional line C shown on FIGS. 1 and 2. FIG. 3 shows the plane of symmetry P parallel to the receiving direction R and the Cartesian direction x. Thus, arranged symmetrically arranged the plane P, FIG. 3 shows the lateral portions 15a, 15b with respective first link beams 21a, 21b and end portions 17a, 17b. The receiving hollow 7 is defined at least by the bottom surface 13a provided by the base portion 13, the top surfaces 19a, 19b provided by the end portions 17a, 17b and the rear surfaces 43a, 43b provided by the rear protrusions 41a, 41b.

As described with respect to FIG. 2, the end portions 17a, 17b comprise a depression region U forming a first U-shape U1 along the receiving direction R. FIG. 3 illustrates that the depression region also forms a second U-shape U2 in a plane orthogonal to the receiving direction R. The second U-shape U2 of the depression region U also softens the edge points 45a, 45b of the end portions 17a, 17b bent together to form the top side of the receiving hollow 7. Thus, the risk of chafing and or plating damage to a male electrical terminal during insertion, extraction, or in use under vibrational load, is further reduced.

The four lamellae 35 of the contacting portion 33 are bent inwardly from the base portion 13 into the receiving hollow 7. As visible for example on FIG. 6, the lamellae 35 extend along the receiving direction R

A male electrical terminal, such as terminal 100 shown in FIG. 4, can be received in the receiving hollow 7 to establish an electrical contact and realize an electrical connection. When received in the hollow, a contact normal force is applied on the male electrical terminal by female electrical terminal. In particular, contact normal forces C1 are applied by the lamellae 35 on the male terminal, and contact normal forces C2 are applied by the end portions 17a, 17b on the male electrical terminal. The contact normal forces C1, C2, are related to the resilience of the lamellae 35 and the end portions 17a, 17b, which in turn depends on their respective structural arrangement and material properties.

To establish an electrical connection, the male electrical terminal is inserted in the hollow 7 with an insertion force sufficient to overcome the contact normal forces C1, C2, i.e. the resilience of the lamellae 35 and the end portions 17a, 17b, and frictional forces. Thus, an electrical contact is realized between an insertion portion of the male terminal on the one hand, and the lamellae 35 and the end portions 17a, 17b on the other hand. Similarly, to open the electrical connection, the male electrical terminal is extracted with an extraction force sufficient to overcome the contact normal forces C1, C2, i.e. the resilience of the lamellae 35 and the end portions 17a, 17b, and frictional forces.

The insertion force and the extraction force are thus directly linked to the contact normal force.

FIG. 4 shows a side view of a male electrical terminal suitable to be inserted in a female electrical terminal according to the invention, in particular the female terminal 1 described above. The male electrical terminal 100 of FIG. 4 comprises an insertion portion 103 and a wiring portion 105, separated by a bridge portion 107. The insertion portion 103 is configured to be inserted by its pointed distal end 101 in a receiving hollow of a female terminal, such as the receiving hollow 7.

The insertion portion 103 has a thickness L1 dimensioned to be greater than a gap of the receiving hollow 7, for example the gap between edge points 45a, 45b and opposite lamellae 35. For example, the insertion portion 103 can have a thickness L1 between 0.5 mm and 2 mm, and the gap be between 0.3 mm and 1.8 mm wide. In one example, the thickness L1 can be of 0.792 +/−0.02 mm and the gap be 0.64 mm +/−0.3 mm wide. Further, the insertion portion 103 has a first surface 109, facing downwards in a Cartesian direction z orthogonal to the receiving direction R, and a second surface 111, opposite the first surface 109.

An electrical terminal system according to the invention comprises a female electrical terminal, such as the female electrical terminal 1, and a male electrical terminal, such as the male electrical terminal 100.

An electrical terminal assembly is an assembled electrical terminal system, in which the female and the male electrical terminal have been assembled by an insertion of an insertion portion of the male electrical terminal in a receiving hollow defined by a receiving portion of the female electrical terminal. For example, in one embodiment of the invention, the male electrical terminal 100 is received in the receiving hollow 7 such that the first surface 109 abuts with the contacting portion 33, specifically the lamellae 35, of the female electrical terminal 1 and the second surface 111 abuts with the end portions 17a, 17b, specifically at the edge points 45a, 45b. Thus, an electrical contact is realized on both sides of the insertion portion 103 of the male electrical contact 100.

The inventive female electrical terminal 1, and the electrical terminal assembly resulting thereof, provides a support beam 27a, 27b which is advantageously suited to be adapted or modified to an application-specific need. The support beam 27a, 27b predominantly contributes to or determines the contact normal force C1, C2 of the terminal 1. The arrangement of the support beam 27a, 27b allows for a convenient modification of its structure in accordance with an application-specific requirement of the female electrical terminal 1.

The female electrical terminal 1 can be cost-efficiently mass-produced and used across a variety of applications and environments, and at the same time be more accurately adapted to the vibrational load of the application. Thus, the user comfort is increased and the risk of damage to contact surfaces during use reduced, without any loss in electrical connection reliability. An exemplary method for manufacturing the terminal 1 will described in the following.

A method for manufacturing a female electrical terminal according to a second embodiment of the invention will now be described. The method is suitable for manufacturing the female electrical terminal 1 of the first embodiment of the invention described here above. As schematically illustrated in FIG. 5A, the method comprises four successive steps I, II, III and IV.

In a first step I, a sheet metal blank is provided. Preferably, the material of the sheet metal blank is a copper-nickel-silicon alloy or a copper-chrome-titanium-silicon alloy, and is entirely silver metal plated prior to beginning the method. In variants, no metal plating or a selective or partial metal plating is provided. In other variants, a metal plating is provided in between the any two of steps I, II, III and IV, or during any one of steps I, II, III and IV of the presently described method. Alternatively, the metal plating is provided after conclusion of the method for manufacturing a female electrical terminal.

In a second step II, executed after the providing step I, the sheet metal blank is formed to the desired shape. The sheet metal blank can formed by stamping, punching, cutting, machining, or any other suitable process to forming the sheet metal blank to the desired shape. The desired shape will be described with reference to FIG. 6, which illustrates a formed sheet metal 200, after conclusion of the bending step II and the modification step III, but prior to a subsequent bending step IV. FIG. 6 shows a plane top view of the formed sheet metal 200.

The sheet metal blank of step I is formed to comprise a wiring portion 5a for the attaching of an electrical wire, and a receiving portion 3 for the receiving of, and electrical contacting with, a male electrical terminal 100 in a receiving direction R. The wiring portion 5a shown on FIG. 6 is larger than the wiring portion 5 of the female electrical terminal 1 and corresponds to an alternative to, or a preliminary stage of, the wiring portion 5. For example, the large wiring portion 5a can be either reduced to a wiring portion 5 for ultrasonic welding, as illustrated by the dashed line, or bent to be suitable for crimping. The wiring portion 5a comprises, along an edge opposed to the receiving portion 3, guiding holes 6a and material cut-outs 6b. The circle-shaped guiding holes 6a are configured to facilitate a continuous guiding of the sheet metal blank in strip inside a stamping tool. The square-shaped material cut-outs 6b serve to reduce mass and save sheet metal material.

The receiving portion 3 comprises a base portion 13 and two lateral portions 15a, 15b on either side of the base portion 13 with respect to the receiving direction R. The base portion 13 comprises a contacting portion 33 for an electrical contacting with the received male electrical terminal 100. Each lateral portion 15a, 15b comprises, respectively, an end portion 17a, 17b, a first link beam 21a, 21b, a support beam 27a, 27b and a second link beam 23a, 23b linking the end portion 17a, 17b to the base portion 13. In each lateral portion 15a, 15b, a first link beam 21, 21b, a support beam 27a, 27b, and a second link beam 23a, 23b is arranged, in parallel and in sequence in the receiving direction R, thus defining a first lateral space 29a, 29b and a second lateral space 31a, 31b between the base portion 13 and respective end portions 19a, 19b.

The receiving portion 3 further comprises the through hole 39. The lateral portions 15a, 15b comprise the rear protrusions 43a, 43b, and the respective notches 37. The contacting portion 33 comprises the four lamellae 35. The lamellae 35 extend along a length L2 of the base portion 13, for example between 20% and 80%, here around 60%, of the total length of the base portion 13.

As understood in view of the female electrical terminal 1, the base portion 13 is configured to form a bottom surface 13a for a receiving hollow 7 of the manufactured female electrical terminal 1. Similarly, the end portions 17a, 17b of the lateral portions 15a, 15b are configured to form a top surface 19a, 19b for a receiving hollow 7 of the manufactured female electrical terminal 1. Similarly, the rear protrusions 41a, 41b of the lateral portions 15a, 15b are configured to form a top surface 19a, 19b for a receiving hollow 7 of the manufactured female electrical terminal 1.

The width V of the receiving hollow 7, corresponding to the width of the base portion 13, determines the width of the insertion portion 103 of the male electrical terminal. In one example, the width V is 12 mm, and the width of the insertion portion of a suitable mating male electrical terminal 100 is 8 mm.

After step II, the support beam 27a, 27b has predetermined dimensions including a thickness, a width along the receiving direction R, and a length. For example, the predetermined thickness can be the thickness T0 of the sheet metal. The predetermined width can be the width W0 of the second link beam 23a, 23b. The predetermined length can be the length L0 of the first link beam 21a, 21b.

In a characterizing step III performed after the forming step II, a dimension of the support beam 27a, 27b is modified, in particular reduced. According to the example shown in FIG. 6 corresponding to the female electrical terminal 1 of FIG. 1, the width of support beam 27a, 27b has been reduced to a width W 5% smaller than the width W0. Additionally, the thickness T has been reduced with respect to the predetermined thickness T0 (not visible of FIG. 6). In this example, the length L has not been modified with respect to the length L0. Alternatively, to obtain the female electrical terminal 1 of FIG. 1, the dimensions of the support beam can be modified to match those described with reference to the terminal 1.

The modification of the dimension is preferably implemented as a function of an insertion force requirement of the insertion of the male electrical terminal 100 in the receiving hollow 7, in particular an insertion force minimum and/or maximum, or of a removal force requirement of the removal of the male electrical terminal 100 from the receiving hollow 7, in particular a removal force minimum and/or maximum, or of a contact normal force C1, C2 requirement of the electrical contact of the male electrical terminal 100 received in the female electrical terminal 1, in particular a contact normal force C1, C2 minimum and/or maximum.

In this way, an optimal balance between minimal insertion and/or extraction forces, for user comfort, and sufficient contact normal forces, for a reliable electrical connection, can be achieved. Specifically, the modification should be dimensioned obtain a structural resilience of the female electrical terminal yielding a contact normal force C1, C2 superior to the vibration-induced acceleration forces expected on the electrical terminal assembly. For example, vibration-induced acceleration forces can range, depending on the environment and the mass, i.e. momentum, between 0.009N and 70N. This the expected acceleration force value may provide a minimal contact normal force requirement.

Therefore, the presently described second embodiment of the invention provides for the manufacture of a female electrical terminal, which can be assembled with a male electrical terminal to an electrical assembly having a contact normal force greater than the vibration acceleration force of the application environment. At the same time, with the modification of the support beams 27a, 27b, the contact normal force C1, C2 can be modified, for example reduced from a generic value much greater, for example 50% greater, to a value slightly greater, specifically only up to 10% greater, than the vibration acceleration force expected in the application environment. Therefore, user comfort is maximized during installation, without jeopardizing the reliability of the electrical connection.

On the other hand, a cable installer may prefer the necessary insertion force, when assembling a female electrical terminal according to the invention, such as terminal 1, with a male electrical terminal, such as terminal 100, to be limited. Therefore, a modus of assembly may provide a maximal insertion force requirement.

As mentioned, the mass connected to an electrical terminal contributes by momentum to the vibrational load, i.e. the acceleration forces, that are experienced by an electrical terminal assembly. For example, the lengths and the size, such as the diameter or cross-sectional area of the conductive core, of the wires attached to the wiring portions 5, 5a, 105, contribute to the acceleration forces experienced by the terminal assembly.

Therefore, in one variant, the dimension, such as the thickness, width or length, is modified as a function of a property, in particular the diameter and/or size of the core, of the electrical wire intended in the application. As an illustrative example, the thickness of the support beam 27a. 27b can be reduced by 50% for an application-specific requirement of wires having diameters below 10 mm². Generally, the smaller the application-specific wire size, the lower the acceleration forces to be expected, and therefore the further the dimensions of the support beam 27a, 27b can be reduced.

In a further step IV performed after the modifying step III, the lateral portions 15a, 15b are bent to form the receiving hollow 7, in line with the female electrical terminal 1 of the first embodiment. In this step, the flat shape of the formed sheet metal 200 is brought into the desired shape of the female electrical terminal 1, forming the receiving hollow 7. Specifically, in this step, the depression region U and the lamellae 35 can also be bent to protrude inwardly into the receiving hollow 7, and the rear protrusions 41a, 41b can be bent to close the receiving hollow.

In one variant schematically illustrated in FIG. 5B, the modifying step III is executed after the bending step IV. This can be more cumbersome and require different conversion kit tools, but provides the advantage of delaying the modification of a generic female electrical terminal to the moment of installation, enabling a real-time adaptation to an application-specific requirement.

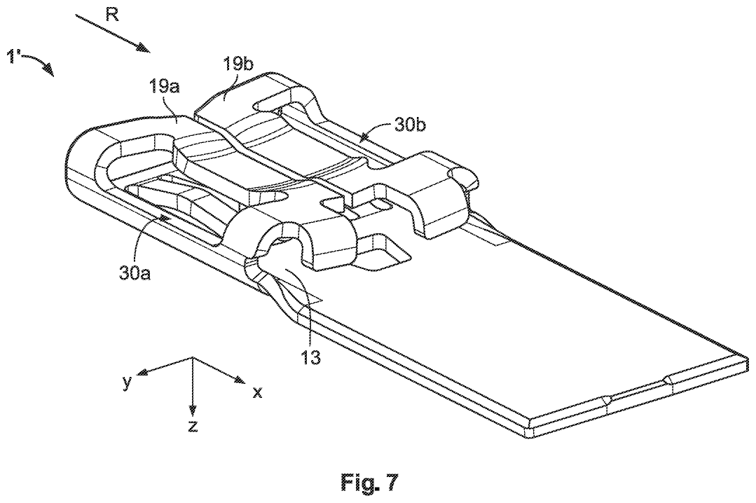

FIG. 7 shows a female electrical terminal 1′, manufactured by the method described above concerning the second embodiment of the invention like the female electrical terminal 1 of FIG. 1. The female electrical terminal 1′ thus represents an alternative product of the method of the second embodiment described hereabove. The female electrical terminal 1′ differs from the female electrical terminal in that the support beams 27a, 27b have been completely removed. In other words, in step III of the method, the dimension T or W or L has been reduced to a value of zero.

The female electrical terminal 1′ thus does not comprise a support beams 27a, 27b linking end portions 17a, 17b to the base portion 13. The first 29a, 29b and second 31a, 31b lateral spaces of the female electrical terminal 1 are thus in FIG. 7 joined to form a respective combined lateral space 30a, 30b. In this configuration, the contact normal force C1, C2 (cf. FIG. 3), the insertion force and the extraction force are significantly reduced, for example by up to 50%. In one example, an insertion force measured for the female electrical terminal 1′ falls within the range 11.6N to 20.6N, while the same measurement applied to a corresponding female electrical terminal 1 falls within the range 25.4N to 36.9N, with an average reduction of insertion force of around 47%. In this example, similar measurements of an extraction force yield average extraction force reduction of 51%, for the female electrical terminal 1′ when compared to the female electrical terminal 1.

The features of the various aspects, variants, and embodiments of the invention described in the present specification can be freely combined with each other to obtain further embodiments or examples according to the invention.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Method for manufacturing a female electrical terminal comprising the steps of:
a) Providing a sheet metal blank
b) Forming the sheet metal blank to include:
a wiring portion for the attaching of an electrical wire, and
a receiving portion for the receiving of a male electrical terminal in a receiving direction, the receiving portion including a base portion and two lateral portions,
the base portion being configured to form a bottom surface of a receiving hollow of the manufactured female electrical terminal and including a contacting portion for an electrical contacting with the received male electrical terminal, and
each lateral portion including, respectively:
an end portion configured to form a top surface of the receiving hollow,
at least one link beam linking the end portion to the base portion, and
a support beam also linking the end portion to the base portion,
the support beam having predetermined dimensions including a thickness, a width along the receiving direction, and a length in a plane orthogonal to the receiving direction,
c) Bending the lateral portions to form the receiving hollow, and
d) modifying, in particular, reducing, at least one dimension of the support beam, in particular the thickness, and/or the width, and/or the length.

2. Method according to claim 1, wherein step d) is executed between step b) and step c).

3. Method according to claim 1, wherein step d) is executed after step c).

4. Method according to claim 1, wherein the dimension is modified, in particular reduced, as a function of a property, in particular the diameter and/or size of the core, of the electrical wire to be attached to the wiring portion.

5. Method according to claim 1, wherein the dimension is modified, in particular reduced, as a function of an insertion force requirement of the insertion of the male electrical terminal in the receiving hollow, in particular an insertion force minimum and/or maximum.

6. Method according to claim 1, wherein the dimension is modified, in particular reduced, as a function of a removal force requirement of the removal of the male electrical terminal from the receiving hollow, in particular a removal force minimum and/or maximum.

7. Method according to claim 1, wherein the dimension is modified, in particular reduced, as a function of a contact normal force requirement of the electrical contact of the male electrical terminal received in the female electrical terminal, in particular a contact normal force minimum and/or maximum.

8. Female electrical terminal comprising:
a wiring portion for the attaching of an electrical wire; and
a receiving portion for the receiving of a male electrical terminal in a receiving direction in a receiving hollow,
the receiving portion including a base portion and two lateral portions, wherein the two lateral portions are bent with respect to the base portion to form the receiving hollow,
the base portion forming a bottom surface of the receiving hollow and including a contacting portion for an electrical contacting with the received male electrical terminal,
each lateral portion includes, respectively:
an end portion forming a top surface of the receiving hollow, a first link beam and a second link beam, the first and second link beams arranged in parallel and linking the end portion to the base portion, wherein the first link beam is arranged at a proximal end of the receiving portion in the receiving direction, and the second link beam is arranged at a distal end of the receiving portion in the receiving direction, and
a support beam also linking the end portion to the base portion, the support beam being arranged in parallel to and in between the first and the second link beam.

9. Female electrical terminal according to claim 8, the support beam having a thickness smaller, in particular 5% to 90% smaller, than a corresponding thickness of the first and/or of the second link beam.

10. Female electrical terminal according to claim 8, the support beam having a width along the receiving direction smaller, in particular 5% to 90% smaller, than a corresponding width of the first and/or of the second link beam.

11. Female electrical terminal according to claim 8, wherein the second link beam includes a notch in a region of joining of the second link beam and the base portion, in particular wherein the notch faces in the receiving direction and has a depth 10% to 50% of the width of the second link beam.

12. Female electrical terminal according to claim 8, wherein the end portions of the respective lateral portions, when bent to form the receiving hollow, define, in a plane orthogonal to the receiving direction and/or in a plane parallel to the receiving direction, a U-shaped top surface.

13. Female electrical terminal according to claim 8 wherein the support beam has a reduced dimension, in particular the thickness, and/or the width, and/or the length compared to the first link beam and the second link beam.

14. Female electrical terminal according to claim 8, wherein the reduced dimension of the support beam is reduced by an amount corresponding to the diameter and/or size of the core of the electrical wire to be attached to the wiring portion.

15. Female electrical terminal according to claim 8, wherein the reduced dimension of the support beam is reduced by an amount corresponding to an insertion force requirement of the insertion of the male electrical terminal in the receiving hollow, in particular an insertion force minimum and/or maximum.

16. Female electrical terminal according to claim 8, wherein the reduced dimension of the support beam is reduced by an amount corresponding to a contact normal force requirement of the electrical contact of the male electrical terminal received in the female electrical terminal, in particular a contact normal force minimum and/or maximum.

17. Electrical terminal assembly comprising:
a female electrical terminal including a wiring portion for the attaching of an electrical wire and a receiving portion having a receiving hollow, the receiving portion includes a base portion and two lateral portions, wherein the two lateral portions are bent with respect to the base portion to form the receiving hollow, the base portion forming a bottom surface of the receiving hollow and including a contacting portion for an electrical contacting with the received male electrical terminal, wherein each lateral portion includes, respectively, an end portion forming a top surface of the receiving hollow, a first link beam, a second link beam, a support beam, the first and second link beams arranged in parallel and linking the end portion to the base portion, wherein the first link beam is arranged at a proximal end of the receiving portion in the receiving direction, and the second link beam is arranged at a distal end of the receiving portion in the receiving direction, the support beam linking the end portion to the base portion and being arranged in parallel to and in between the first and the second link beam; and
a male electrical terminal;
wherein the male electrical terminal is received in the receiving hollow in a receiving direction such that a first surface of the male electrical terminal abuts with the contacting portion of the female electrical terminal, and a second surface of the male electrical terminal opposed to the first surface abuts with the end portions of the female electrical terminal, realizing the electrical contacting.

18. Electrical terminal assembly according to claim 17, wherein a thickness, and/or a width along the receiving direction, and/or a length in a plane orthogonal to the receiving direction, of the support beam, is function of a property, in particular the diameter and/or size of the core, of the electrical wire to be attached to the wiring portion.

19. Electrical terminal assembly according to claim 17 realizing an electrical connection in an application environment, wherein the contact normal force of the electrical contacting corresponds to the vibration acceleration force of the application environment.

20. Electrical terminal assembly according to claim 17 realizing an electrical connection in an application environment, wherein the contact normal force of the electrical contacting is up to 10% greater than the vibration acceleration force of the application environment.
